(19) United States
(12) Patent Application Publication
(10) Pub. No.: US 2003/0092419 A1
(43) Pub. Date: May 15, 2003

(54) Method and apparatus for a near-unity divider in a direct conversion communication device

(76) Inventors: Dan Nobbe, Crystal Lake, IL (US); Vikram Karnani, Chicago, IL (US)

Correspondence Address: MOTOROLA INC, 600 NORTH US HIGHWAY 45, LIBERTYVILLE, IL, 60048-5343, US

(21) Appl. No.: 10/039,812

(22) Filed: Nov. 9, 2001

(51) Int. Cl. H04B 1/26

(52) U.S. Cl. 455/324; 455/180.1

(57) ABSTRACT

A near-unity divider apparatus in a direct conversion communication device includes a reference frequency, that is not on-channel, input to a multiply-by-two circuit that doubles the reference frequency. A divide-by-three circuit divides the doubled frequency by three to provide a first fractionally-divided frequency at a transmit or receive frequency. A delay generator inputs the first fractionally-divided frequency from the divide-by-three circuit and provides a second fractionally-divided frequency delayed a predetermined time period. A gate circuit combines the first and second fractionally-divided frequencies to provide a transmit or receive frequency with an adjustable duty cycle dependant upon the predetermined time period.

### TECHNICAL FIELD OF THE INVENTION

This invention relates in general to electrical circuits, and more specifically to a method and apparatus of a frequency divider architecture in a communication device.

### BACKGROUND OF THE INVENTION

Typically in a two-way radio, a frequency synthesizer is used to generate a receive local oscillator (LO) signal and a transmit carrier. The frequency bands for receive and transmit operation may or may not be the same for the two-way radio. Differences may result from the receiver architecture (e.g., superheterodyne), system design (e.g., separate frequency blocks for transmit and receive signals) or transmitter architecture (e.g., direct conversion or frequency offset). When the radio's transmitter is operative, signals from the LO may be coupled to and transmitted from the antenna. Such unmodulated carrier power can disrupt sensitive system power control measures, such as is used in a Code Division Multiple Access (CDMA) system. In particular, direct conversion radios are susceptible to this problem.

In a direct conversion radio, frequency conversion is performed only once, i.e., baseband signals are directed modulated at the carrier RF frequency. To implement direct conversion in a multi-band (and multi-mode) radio, very precise frequency planning is required. Otherwise, intermodulating frequency by-products appear in the form of unwanted spurious signals in an operating passband or receive band. This problem results in carrier power control disruption.

CDMA systems control the power of the transmit output down to −50 dBm. Since there is a standardized requirement to meet a 30 dB carrier suppression specification, any unmodulated carrier power at the antenna, or radiating from the radio, must be below −80 dBm. This limit is very difficult to meet with a local oscillator that operates at the carrier frequency, such as is the case with a direct conversion architecture.

Two approaches have been used to meet the requirements of this radio environment. These approaches are the offset loop and the image-balanced mixer. In the offset loop approach, a phase-locked loop (PLL) comprising a phase detector, loop filter, voltage-controlled oscillator (VCO), offset mixer and offset signal source are connected between the synthesizer output and the input of the transmitter gain and linearization path. The offset loop shifts the output frequency of the synthesizer VCO by an amount equal to the offset signal frequency. The loop tends to limit spurious responses caused by the presence of the offset signal.

The offset loop approach has the limitation that, in order to minimize the spurious frequencies of the offset loop due to unwanted mixing products, the mixer must be operated such that its response is highly linear. This tends to increase power consumption and limits the noise floor of the system. Another limitation of the offset loop approach is that an additional signal must be provided to the system. Generation of the offset signal increases the cost of the design as well as increases the power consumption for the radio. Also, the presence of the offset signal creates an opportunity for a spurious output of the loop that is only mitigated by the action of the PLL.

In the image-balanced mixer approach, the synthesizer output is mixed with an offset signal and no loop is used to remove spurs from the output. This design is limited to use in systems where the transmit frequency range is much smaller than the offset frequency. A multi-pole filter is required to remove the offset and higher order spurs from the mixer output. The filter however adds cost to the design and constrains the operating frequency range of the transmitter.

A need thus exists for generating a carrier frequency in a direct conversion radio without the use of an offset loop while minimizing spurious signals at the carrier frequency. It would also be of benefit to provide this without complication circuitry at a low cost.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 shows a simplified block diagram of a frequency generation system, in accordance with the present invention;

FIG. 2 shows a timing diagram of the frequency generation system of FIG. 1; and

FIG. 3 shows a flow diagram of a preferred embodiment of a method of frequency generation, in accordance with the present invention.

While the specification concludes with claims defining the features of the invention that are regarded as novel, it is believed that the invention will be better understood from a consideration of the following description in conjunction with the drawing figures, in which like reference numerals are carried forward.

### DETAILED DESCRIPTION OF THE PREFERRED EMBODIMENT

The invention comprises a frequency generation system for a radio communication device. The present invention includes a near-unity divider that is used to internally generate an on-channel local oscillator signal from a reference frequency source, such as a voltage controlled oscillator (VCO) for example. The near-unity divider can be incorporated solely within an integrated circuit, which provides better frequency isolation properties. Moreover, the on-channel leakage meets the standard modulator carrier suppression specification and will be further attenuated by the circuit stages following the modulator. The divider as described below is a “double then divide” architecture. It can be run in double, divide-by-two, or fractional divide modes, with an output noise adequate for modulator signal-to-noise requirements.

The present invention is best utilized in CDMA or wideband CDMA systems, since these systems include existing filters before and after the power amplifier stage, which can be used to advantage. For example, in Time Division Multiple Access (TDMA) and Global System for Mobile (GSM) communication systems the noise requirement at the modulator output is very stringent. Although the present invention can be used in these communication systems, the noise floor of the divider would limit the noise performance of the entire transmitter line-up, which would consequently necessitate the use of filters before and after the transmitter power amplifier. However, CDMA and wideband CDMA communication systems already have these filters in their transmitter stages. Being full duplex systems, the noise in the receive band due to the transmitter requires heavy attenuation, which is achieved by the filters before and after the transmitter power amplifier. These filters ease the noise performance requirement of the divider on the rest of the transmitter.

The near-unity divider of the present invention serves to reduce the carrier leakage out of the radio and the antenna. In CDMA and wideband CDMA communication systems, at least 80 dB of carrier isolation is required between the local oscillator and the antenna. In TDMA communication systems, the local oscillator signal is fed into the transmitter modulator from a VCO module. This arrangement requires routing a high frequency signal across circuit board traces. The presence of this signal on these traces makes it difficult to isolate the antenna from the local oscillator signal since some local oscillator power will be radiated from the trace on the circuit board into the antenna or directly radiated from the radio. By incorporating the near-unity divider of the present invention within the modulator integrated circuit, the problem of signal radiation from a trace on the printed circuit board is eliminated. The only carrier leakage present would come at the modulator itself, but this is common to all communication systems, irrespective of injection method.

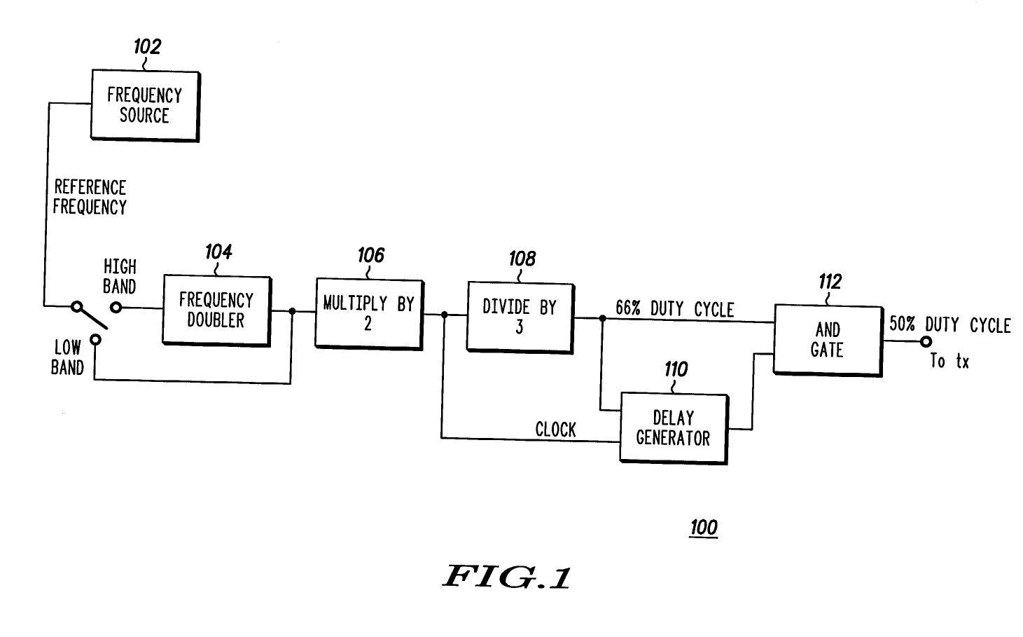

Referring now to FIG. 1, there is shown a divider 100 with near-unity modulus (a near-unity divider) in accordance with the invention. The purpose of the divider is to produce a division ratio near unity. The near-unity divider 100 can be provided as a programmable divider with a fractional divide ratio, but it is preferred that the divider is implemented with a fixed ratio of 1.5. This ratio was chosen to select the lowest, easily achievable divide ratio as close to unity as possible. Being close to unity causes the divider noise floor to be low since there is only one stage of division. Being at 1.5 avoid spurious frequency products while using an easily implemented circuit, as will be described below. Selecting the divide ratio as 1.5 achieves both of these objectives. In addition, this ratio ensures that the carrier is at least 30 dB below the transmit frequency.

A frequency source 102 provides a reference frequency. The frequency source 102 can be a frequency synthesizer or VCO, for example. The near-unity divider 100 further includes an input port for receiving the reference frequency from the frequency source and output port for providing an output signal to a receiver demodulator mixer or transmitter modulator mixer, for example. The divider 100 uses a multiply-by-two circuit 106 cascaded with a divide-by-three circuit 108. The multiply-by-two circuit 106 doubles the reference frequency and outputs the doubled frequency. Preferably, the multiply-by-2 circuit is an ECL EX-OR circuit, with feedback though a D flip flop. The EX-OR gate input are the reference frequency and the delayed reference frequency. The output of the EX-OR is twice the reference frequency. The divide-by-three circuit 108 is coupled to the multiply-by-two circuit 106 to produce a divide ratio of 1.5. Note that dividers with other ratios can be implemented without changing the key features of the invention. The divide-by-three circuit 108 divides the doubled frequency by three to output a first fractionally-divided frequency.

In general, the divide-by-three circuit 108 incorporates a cascaded network or logic gates, such as a cascade of OR and exclusive-OR gates, as is known in the art. Due to the simplicity of the use of the logic gates (which cannot split cycles without complex timing circuits), the divide-by-three circuit 108 will input three cycles and produce a high logic value on one or two of the input cycles and a low logic value on the remainder of the three input cycles. The divide-by-three circuit 108 outputs a resulting signal that is one-third the frequency of the doubled frequency from the multiply-by-two circuit 106, or equivalently the reference frequency divided by 1.5. In other words, the divide-by-three circuit 108 outputs a first fractionally-divided frequency. However, because the divide-by-three circuit 108 inputs three cycles and produce a high logic value on one or two of the input cycles and a low logic value on the remainder of the three input cycles, the duty cycle of the first fractionally-divided frequency is either one-third or two-thirds (thirty-three or sixty-six percent). In the example shown in FIG. 1, a sixty-six percent duty-cycle is shown, for example.

The output of the divide-by-three circuit 108 is at the required receive or transmit carrier frequency. However, the two-thirds (or one-third) duty cycle contains a high amount of second harmonic content, which is very undesirable. In order to reduce the second harmonic content, the present invention utilizes a delay generator 110 and gate circuit 112 to provide an correct output frequency with a fifty-percent duty cycle. The delay generator 110 is coupled to the divide-by-three circuit 108 and inputs the first fractionally-divided frequency (the reference frequency divided by 1.5) from the divide-by-three circuit 108 to provide a second fractionally-divided frequency with the same frequency but shifted a predetermined time period. In a preferred embodiment, the delay generator 110 is coupled to the multiply-by-two circuit 106 to uses the doubled frequency as a clock. In particular, the predetermined time period is one half clock cycle such that the duty cycle is fifty-percent. More particularly, the predetermined time period is a delay of one half clock cycle. In practice, the delay generator 110 is a D-type flip-flop which uses the clock signal from the multiply-by-two circuit 106 and delays the first fractionally-divided signal from the divide-by-three circuit 108 by one-half clock cycle, to provide the delayed second fractionally-divided signal having the same frequency as the first fractionally-divided signal, but delayed one-half clock cycle.

The gate circuit 112 combines the first fractionally-divided frequency from the divide-by-three circuit 108 and the second fractionally-divided frequency from the delay generator 110 to provide a fractionally-divided frequency output with an adjustable duty cycle dependant upon the predetermined time period. Preferably, the predetermined time period is one half clock cycle such that the duty cycle of the output signal is fifty-percent. This can be accomplished simply by use of and AND gate for the gate circuit.

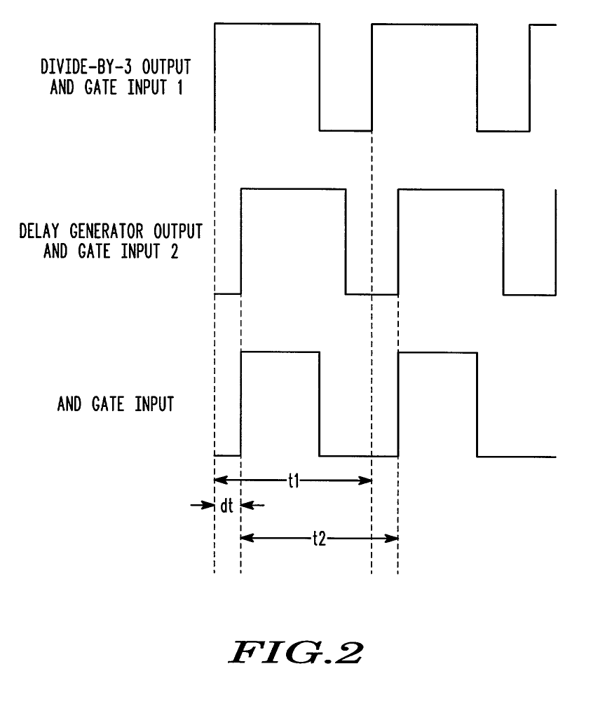

FIG. 2 shows a timing diagram representing the operating of the gating circuit 112 of FIG. 1. One input of the AND gate is coupled with the first fractionally-divided frequency from the divide-by-three circuit and having a two-thirds duty cycle of a period, t1. The other input of the AND gate is coupled with the second fractionally-divided frequency from the delay generator, which is the same as the first fractionally-divided frequency from the divide-by-three circuit with a delay, dt. The second fractionally-divided frequency has a two-thirds duty cycle of a period, t2, equal to t1. When these two signal are operated on by the AND gate, a fifty-percent duty cycle fractionally-divided signal is produced having the same frequency as the first (and second) fractionally-divided signals. This substantially eliminates the second harmonic products in the output frequency. It should be noted that if the first and second fractionally-divided signals had one-third duty cycles, then an OR-gated circuit would be used to provide a fifty-percent duty cycle output.

In application, the AND gate output is used for the in-phase signal output (I output) for a quadrature modulator, as is used in radio communication systems such as CDMA, for example. A quadrature output (or the Q output) which is ninety degrees out of phase with the I signal can be generated by using an active quadrature generation circuit, which comprises a multiply-by-two stage followed by a divide-by-two stage and includes a duty cycle control loop. The Q output would be the output of the master stage in the divide-by-two circuit, which is basically a D-type flip-flop in a master slave configuration.

In practice, the present invention generates either a receive local oscillator signal or transmit injection signal or both simultaneously. Frequency adjustments to the frequency synthesizer, such as FM modulation and reference oscillator warp, pass through the system of the present invention undistorted. In this light, the present invention can be modified to operate in a dual-band radio. For example, dual-band spectrum in existing communication systems can cover the 900 MHz band and the 1800 MHz band. By incorporating a switchable frequency doubler 104, as shown in FIG. 1, coupled before the multiply-by-two circuit 106, the frequency doubler doubles the operating frequencies of the local oscillator such that operation in both bands can be accommodated in the present invention. The frequency doubler can be coupled before or after the multiply-by-two circuit 106 or at the end of the divider 100. The operation of the divider, as described previously, is the same whether operating in the high band or the low band, with a corresponding doubling of the divider output frequency to the transmitter or receiver of the radio. To operate in the high band, the doubler 104 is switched in cascade with the divider. To operate in the low band, the doubler 104 is switch out of the divider.

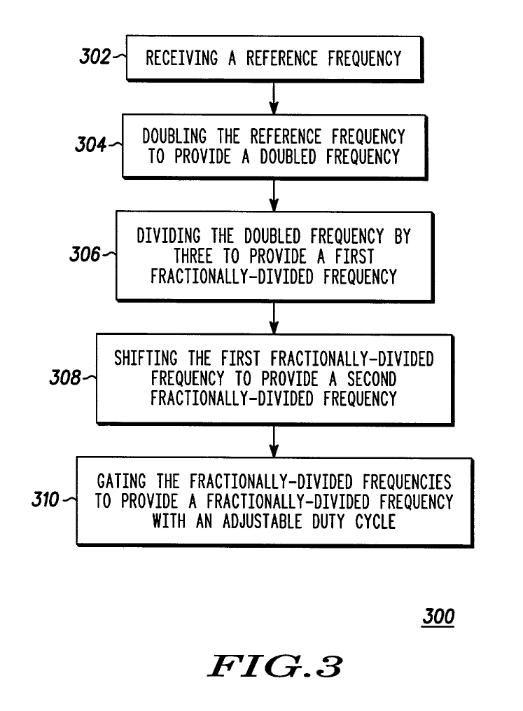

The present invention also incorporates a method 300 of limiting on-channel frequencies in a direct conversion communication device, as shown in FIG. 3. A first step of the method includes receiving 302 a reference frequency from a frequency source. A next step includes doubling 304 the reference frequency to provide a first doubled frequency. A next step includes dividing 306 the first doubled frequency by three to provide a first fractionally-divided frequency. In practice, this results in the first fractionally-divided frequency having one-third or two-thirds duty cycle when using simple cascaded logic gates. A next step includes shifting 308 the first fractionally-divided frequency to provide a second fractionally-divided frequency. Preferably, the shifting step includes clocking the first fractionally-divided frequency with the first doubled frequency. More preferably, the shifting step includes clocking the first fractionally-divided frequency with the first doubled frequency and shifting the second fractionally-divided frequency by one-half clock cycle of the doubled frequency such that the gating step provides a resultant duty cycle of fifty-percent. In particular, the shifting is actually a delaying of one-half clock cycle. In addition, the shifting step can use a D-type flip-flop for delaying the second fractionally-divided frequency by one-half clock cycle behind the first fractionally-divided frequency. A next step includes gating 310 the first and second fractionally-divided frequencies to provide a fractionally-divided frequency with an adjustable duty cycle dependant upon the predetermined time period. Preferably, AND gating is used where the fractionally-divided frequencies have a two-thirds duty cycle. Also, in a preferred dual-band embodiment, the method includes a further step of providing a switchable frequency doubler for switchably doubling the reference frequency from the frequency source.

While the preferred embodiments of the invention have been illustrated and described, it will be clear that the invention is not so limited. Numerous modifications, changes, variations, substitutions and equivalents will occur to those skilled in the art without departing from the broad scope of the present invention as defined by the appended claims.

What is claimed is:

1. A near-unity divider apparatus in a direct conversion communication device, the divider comprising:
a reference frequency output from a frequency source;
a multiply-by-two circuit that doubles the reference frequency and outputs the doubled frequency;
a divide-by-three circuit coupled to the multiply-by-two circuit, the divide-by-three circuit divides the doubled frequency by three to output a first fractionally-divided frequency;
a delay generator coupled to the divide-by-three circuit, the delay generator inputs the first fractionally-divided frequency from the divide-by-three circuit and provides a second fractionally-divided frequency shifted a predetermined time period; and
a gate circuit that combines the first and second fractionally-divided frequencies to provide a fractionally-divided frequency with an adjustable duty cycle dependant upon the predetermined time period.

2. The apparatus of claim 1, wherein the delay generator is coupled to the multiply-by-two circuit, wherein the delay generator uses the doubled frequency as a clock.

3. The apparatus of claim 1, wherein the delay generator is coupled to the multiply-by-two circuit, wherein the delay generator uses the doubled frequency as a clock, and the predetermined time period is one half clock cycle such that the duty cycle is fifty-percent.

4. The apparatus of claim 1, wherein the gate circuit is an AND gate.

5. The apparatus of claim 1, wherein the delay circuit is a D-type flip-flop.

6. The apparatus of claim 1, further comprising a switchable frequency doubler coupled in the divider, wherein the frequency doubler switchably doubles the operating frequencies of the apparatus.

7. The apparatus of claim 1, wherein the first fractionally-divided frequency has a two-thirds duty cycle.

8. A direct conversion radio communication apparatus with a near-unity divider for limiting on-channel frequencies, the apparatus comprising:
a reference frequency output from a frequency source;
a multiply-by-two circuit that doubles the reference frequency and outputs the doubled frequency;
a divide-by-three circuit coupled to the multiply-by-two circuit, the divide-by-three circuit divides the doubled frequency by three to output a first fractionally-divided frequency;
a delay generator coupled to the multiply-by-two circuit and the divide-by-three circuit, the delay generator uses the doubled frequency from the multiply-by-two circuit as a clock and inputs the first fractionally-divided frequency from the divide-by-three circuit to provide a second fractionally-divided frequency delayed a predetermined time period; and
an AND gate circuit that combines the first and second fractionally-divided frequencies to provide a fractionally-divided frequency with an adjustable duty cycle dependant upon the predetermined time period.

9. The apparatus of claim 8, wherein the predetermined time period is one half clock cycle such that the duty cycle is fifty-percent.

10. The apparatus of claim 8, wherein the delay circuit is a D-type flip-flop.

11. The apparatus of claim 8, further comprising a switchable frequency doubler coupled in the divider, wherein the frequency doubler doubles the operating frequencies of the apparatus.

12. The apparatus of claim 8, wherein the first fractionally-divided frequency has a two-thirds duty cycle.

13. A method of limiting on-channel frequencies in a direct conversion communication device, the method comprising the steps of:
receiving a reference frequency from a frequency source;
doubling the reference frequency to provide a first doubled frequency;
dividing the first doubled frequency by three to provide a first fractionally-divided frequency;
shifting the first fractionally-divided frequency to provide a second fractionally-divided frequency; and
gating the first and second fractionally-divided frequencies to provide a fractionally-divided frequency with an adjustable duty cycle dependant upon the predetermined time period.

14. The method of claim 13, wherein the shifting step includes clocking the first fractionally-divided frequency with the first doubled frequency.

15. The method of claim 13, wherein the dividing step provides a first fractionally-divided frequency with a two-thirds duty cycle.

16. The method of claim 13, wherein the gating step uses AND gating.

17. The method of claim 13, wherein the shifting step uses a D-type flip-flop.

18. The method of claim 13, further comprising a step of providing a switchable frequency doubler for switchably doubling the reference frequency from the frequency source.

19. The method of claim 13, wherein the shifting step includes clocking the first fractionally-divided frequency with the first doubled frequency and shifting the second fractionally-divided frequency by one-half clock cycle such that the gating step provides a duty cycle of fifty-percent.

20. The method of claim 19, wherein the shifting step includes delaying the second fractionally-divided frequency by one-half clock cycle.
